(19) United States
(12) Patent Application Publication
(10) Pub. No.: US 2004/0194016 A1
(43) Pub. Date: Sep. 30, 2004

(54) Dynamic data migration for structured markup language schema changes

(75) Inventor: Jordan T. Liggitt, Leasburg, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/403,342

(22) Filed: Mar. 28, 2003

(51) Int. Cl. G06F 15/00

(52) U.S. Cl. 715/501.1

(57) ABSTRACT

Techniques are disclosed for programmatically migrating structured documents created according to one version of a schema such that those structured documents may adhere to a revised version of the schema (or schema equivalent, alternatively). A “schema change document” is used to record changes that have been made to the schema. This schema change document provides a single point of access for implementing programmatic revisions for a single source file or for an entire set of source files that may have become out of alignment with its schema. The source file(s), or a copy thereof, can then be changed programmatically in view of the recorded schema changes, without having to manually search for and change all of the source files that are dependent on a changed schema

### BACKGROUND OF THE INVENTION

1. Field of the Invention

The present invention relates to computer software, and deals more particularly with techniques for programmatically migrating structured documents created according to one version of a schema such that those structured documents may adhere to a revised version of the schema (or schema equivalent, alternatively).

2. Description of the Related Art

The popularity of distributed computing networks and network computing has increased tremendously in recent years, due in large part to growing business and consumer use of the public Internet and the subset thereof known as the “World Wide Web” (or simply “Web”). Other types of distributed computing networks, such as corporate intranets and extranets, are also increasingly popular. As solutions providers focus on delivering improved Web-based computing, many of the solutions which are developed are adaptable to other distributed computing environments. Thus, references herein to the Internet and Web are for purposes of illustration and not of limitation.

Use of structured documents encoded in a structured markup language has become increasingly prevalent in recent years as a means for exchanging information between computers in distributed computing networks. In addition, many of today's software products are written to produce and consume information which is represented using these types of structured documents. The Extensible Markup Language, or “XML”, for example, is a markup language which has proven to be extremely popular for encoding structured documents for exchange between parties (and also for describing structured data). XML is very well suited for encoding document content covering a broad spectrum. XML has also been used as a foundation for many other derivative markup languages, such as the Wireless Markup Language (“WML”), VoiceXML, MathML, and so forth. These markup languages are well known in the art.

For the early uses of structured documents, and in particular for XML version 1.0, a Document Type Definition (“DTD”) was used for specifying the grammar for a particular structured document (or set of documents). That is, a DTD specifies the set of allowable markup tags, where this set indicates the permissible elements and attributes to be used in the document(s). In more recent years, a “schema” is commonly used instead of a DTD. A schema contains information similar to that in a DTD, but is much more functionally rich, and attempts to specify more requirements for the structured documents which adhere to it. As stated by the World Wide Web Consortium (“W3C”), “XML Schemas express shared vocabularies and allow machines to carry out rules made by people. They provide a means for defining the structure, content and semantics of XML documents.”. Documents discussing schemas may be found in many places, including the W3C Web site. Today, schemas are well known in the art.

There may be situations where a schema is undergoing revision, as the content and/or format of the structured documents that will adhere to the schema is redesigned. During development of a software product, for example, non-finalized XML schemas may be changed frequently, often in very minor ways. Addition of a new software feature might require that an additional property be added to the schema, or that a schema property be moved to a different logical location. Revising the schema has the effect of invalidating all existing XML files that are currently validated against that schema. In the case of a major software development project, this could mean the need for sweeping hundreds of files, making the same minor change (or changes) in each one. As will be obvious, revising the XML files to adhere to the new schema is a time-consuming task. Even more troubling for the software developer, though, may be the workflow interruption caused when the validation process for a file “breaks” due to the file becoming out of alignment with the changed schema. And when the schema is still fluctuating, it may happen that changes made one day are reversed the next day, exacerbating the problem for the software developers.

It is desirable to provide techniques for addressing these problems of the prior art.

### SUMMARY OF THE INVENTION

An object of the present invention is to provide techniques for programmatically migrating structured documents created according to one version of a schema such that those structured documents may adhere to a revised version of the schema.

Another object of the present invention is to provide techniques for dynamically migrating data encoded in a structured markup language such that the data aligns with a revised data definition.

A further object of the present invention is to provide techniques for programmatically attempting to repair structured document content that fails a validation process.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for programmatically migrating data. In preferred embodiments, this technique comprises: recording one or more changes that are made to a first structured language specification when creating a second structured language specification; and using the recorded changes to programmatically migrate contents of a source file encoded to adhere to the first structured language specification such that it adheres to the second structured language specification. Preferably, the changes are recorded in a single location, and in particular, this single location is preferably a change file that is identified in, but physically separate from, the second structured language specification.

The first structured language specification and the second structured language specification are preferably schemas (or schema equivalents).

Optionally, the recorded changes may represent one or more interim versions of the structured language specification. In this case, a subset of the changes will be the result of creating the interim version(s), and the remaining changes will reflect changing the final interim version to become the second structured language specification. Thus, the source file that is programmatically migrated may have been originally encoded to adhere to any of the interim structured language specifications (rather than the first structured language specification).

The programmatic migration may be responsive to detecting a validation error when attempting to validate the contents of the source file (e.g., using a parser) against the second structured language specification, or it may be triggered in another way, including as a precursor to attempting such a validation. The programmatic migration may comprise revising the contents of the source file, an in-memory representation of the contents of the source file, and/or a copy of the contents of the source file. Optionally, a user may be prompted before changing the contents of one or more of these files.

The source file is preferably encoded in a structured markup language such as XML (or a derivative thereof), and the first and second structured language specifications then define allowable syntax for files encoded in this structured markup language.

The present invention may also be used advantageously in methods of doing business, for example by providing dynamic data migration services for clients. This service may be provided under various revenue models, such as pay-per-use billing, monthly or other periodic billing, and so forth.

The present invention will now be described with reference to the following drawings, in which like reference numbers denote the same element throughout.

### BRIEF DESCRIPTION OF THE DRAWINGS

FIG. 1 is a block diagram of a computer hardware environment in which the present invention may be practiced, according to the prior art;

FIG. 2 is a diagram of a networked computing environment in which the present invention may be practiced, according to the prior art;

FIGS. 3 and 4 illustrate components involved when validating structured documents according to the prior art and according to preferred embodiments of the present invention, respectively;

FIGS. 5-7 provide flowcharts illustrating logic that may be used when implementing preferred embodiments of the present invention;

FIGS. 8 and 9 (comprising FIGS. 8A and 8B, 9A and 9B) provide sample XML documents and their corresponding tree structures, and are used to illustrate operation of preferred embodiments;

FIG. 10 depicts a first version of a sample schema that may be used when validating the XML documents in FIGS. 8A and 9A, and FIG. 11 depicts a modified version of this sample schema that may be used for validating the same documents;

FIG. 12 illustrates the general format of a sample schema change document, created according to preferred embodiments to record how a schema has been changed, and FIG. 13 provides a schema change document that records how the schema in FIG. 10 was changed to create the schema in FIG. 11; and

FIG. 14 illustrates a schema defining the allowable contents (i.e., grammar) of a schema change document, according to preferred embodiments.

### DESCRIPTION OF PREFERRED EMBODIMENTS

The present invention provides techniques for programmatically migrating structured documents created according to one version of a schema, such that those structured documents may adhere to a revised version of the schema. For purposes of illustration but not of limitation, preferred embodiments of the present invention are described in terms of elements of XML documents defined according to an XML schema. However, the inventive concepts disclosed herein may be adapted to elements encoded in other structured markup languages and/or which are defined using other definitional approaches (such as document type definitions, or “DTDs”). Thus, references herein to “XML” and “schema” are intended to encompass functionally similar languages and definitions.

The present invention allows changes to be made to XML schemas without having to manually change all dependent XML files (and without having to search for the files that are dependent). In a typical software development environment, many schema changes may be made that are of minor to moderate complexity, and such changes may be made rapidly and frequently throughout the development process. Using techniques disclosed herein, the dependent XML files can by revised programmatically, using knowledge of the particular schema changes that have been made. (This knowledge also enables determining whether any validation problems that arise are simply due to the schema changes, or instead signify an error in the document-producing logic.)

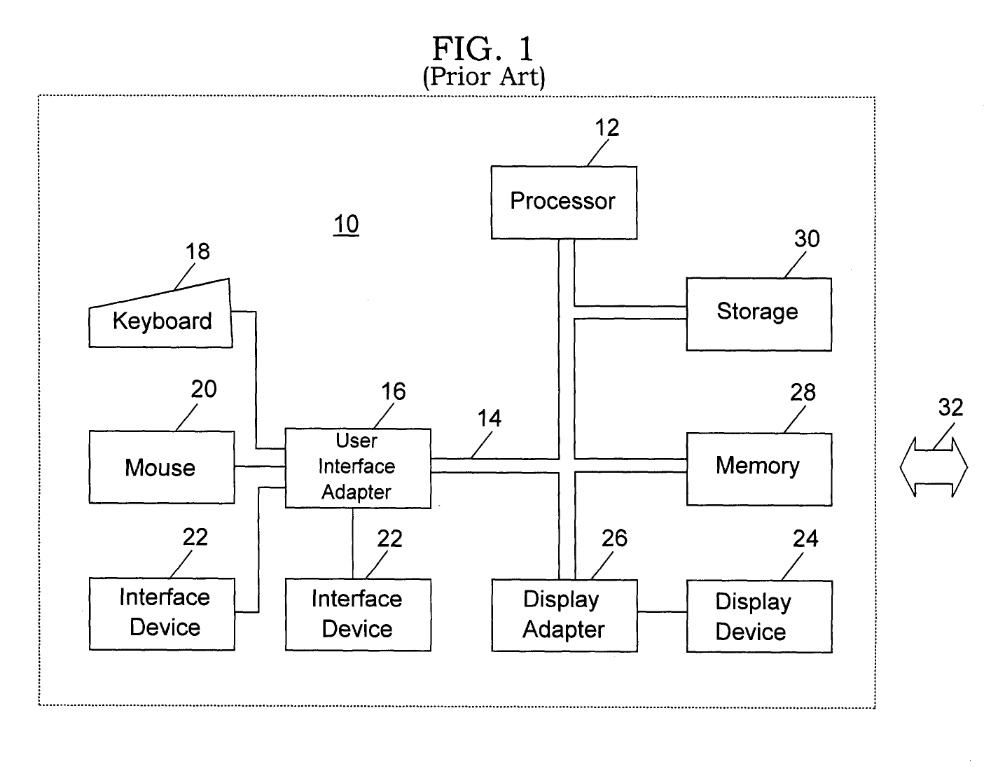

Preferred embodiments of the present invention will now be described with reference to FIGS. 1-14.

FIG. 1 illustrates a representative computer hardware environment in which the present invention may be practiced. The environment of FIG. 1 comprises a representative computer workstation 10, such as a personal computer, including related peripheral devices. The workstation 10 includes a microprocessor 12 and a bus 14 employed to connect and enable communication between the microprocessor 12 and the components of the workstation 10 in accordance with known techniques. The workstation 10 typically includes a user interface adapter 16, which connects the microprocessor 12 via the bus 14 to one or more interface devices, such as a keyboard 18, mouse 20, and/or other interface devices 22, which can be any user interface device, such as a touch sensitive screen, digitized entry pad, etc. The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The workstation 10 may communicate with other computers or networks of computers, for example via a communications channel or modem 32. Alternatively, the workstation 10 may communicate using a wireless interface at 32, such as a cellular digital packet data (“CDPD”) card. The workstation 10 may be associated with such other computers in a local area network (“LAN”) or a wide area network (“WAN”), or the workstation 10 can be a client in a client/server arrangement with another computer, etc. All of these configurations, as well as the appropriate communications hardware and software, are known in the art.

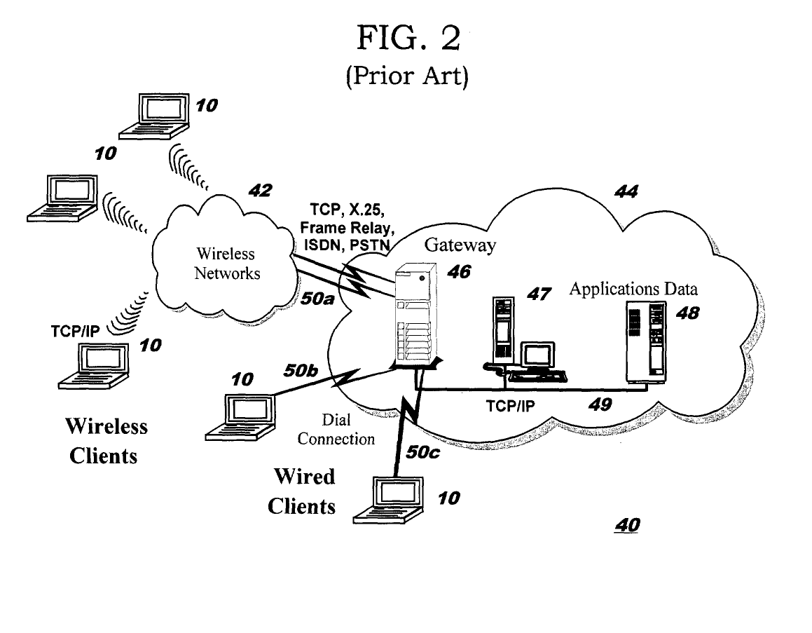

FIG. 2 illustrates a data processing network 40 in which the present invention may be practiced. The data processing network 40 may include a plurality of individual networks, such as wireless network 42 and network 44, each of which may include a plurality of individual workstations 10. Additionally, as those skilled in the art will appreciate, one or more LANs may be included (not shown), where a LAN may comprise a plurality of intelligent workstations coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be coupled to another network 42 by means of a communications link 50a. The gateway 46 may also be directly (or indirectly) coupled to one or more workstations 10 using a communications link 50b, 50c. The gateway computer 46 may also be coupled 49 to a storage device (such as data repository 48). The gateway computer 46 may be implemented utilizing an Enterprise Systems Architecture/370™ available from the International Business Machines Corporation (“IBM®”), an Enterprise Systems Architecture/390® computer, etc. Depending on the application, a midrange computer, such as an Application System/400® (also known as an AS/400®) may be employed. (“Enterprise Systems Architecture/370” is a trademark of IBM; “IBM”, “Enterprise Systems Architecture/390”, “Application System/400”, and “AS/400”are registered trademarks of IBM.)

Those skilled in the art will appreciate that the gateway computer 46 may be located a great geographic distance from the network 42, and similarly, the workstations 10 may be located a substantial distance from the networks 42 and 44. For example, the network 42 may be located in California, while the gateway 46 may be located in Texas, and one or more of the workstations 10 may be located in Florida. The workstations 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or User Datagram Protocol (“UDP”) over IP, X.25, Frame Relay, Integrated Services Digital Network (“ISDN”), Public Switched Telephone Network (“PSTN”), etc. The workstations 10 may alternatively connect directly to the gateway 46 using dial connections 50b or 50c. Further, the wireless network 42 and network 44 may connect to one or more other networks (not shown), in an analogous manner to that depicted in FIG. 2.

In preferred embodiments, the present invention is provided in software. In this case, software programming code which embodies the present invention is typically accessed by the microprocessor 12 of the workstation 10 or server 47 from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems (and their users). Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

The computing environment in which the present invention may be used includes an Internet environment, an intranet environment, an extranet environment, or any other type of networking environment. These environments may be structured in various ways, including a client-server architecture or a multi-tiered architecture. The present invention may also be used in a disconnected (i.e., stand-alone) mode, for example where a user validates an XML file on a workstation, server, or other computing device without communicating across a computing network.

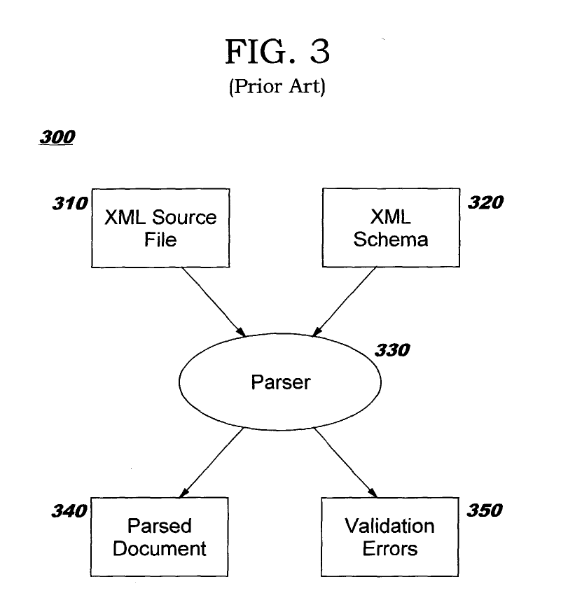

FIG. 3 illustrates components involved when validating structured documents according to the prior art. As shown therein, the validation process 300 comprises supplying an XML source file 310 and an XML schema 320 to a component 330 that is referred to herein as a parser. (While preferred alternatives are described with reference to a parser, an alternative validating component —such as a specially-designed validator—may be used, and such alternatives are within the scope of the present invention.) Parser 330 uses schema 320 to determine, inter alia, whether XML source file 310 is a valid document. Therefore, the terms “parse” and “validate” are used synonymously herein for purposes of describing the present invention. If the source file 310 is valid, then an output of the parsing process is a parsed document 340 (e.g., a stream of tokens and/or a document object model or “DOM” tree). If the source file 310 is not valid, then an output of the parsing process is typically a report of the validation errors 350 that were encountered.

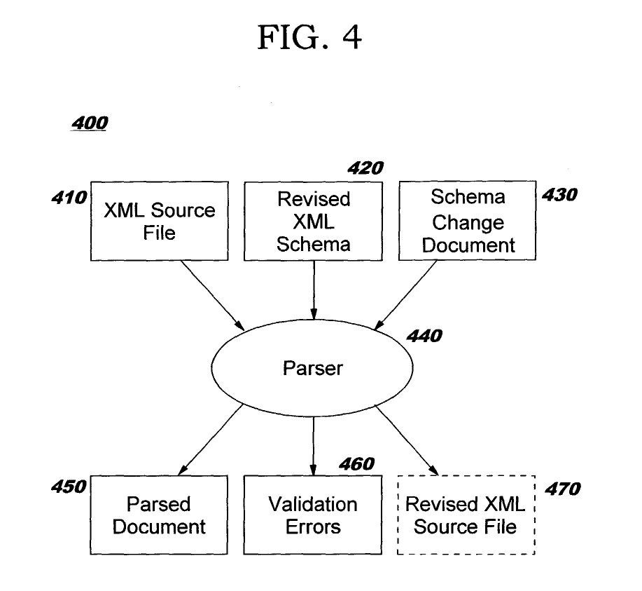

In FIG. 4, components involved when validating structured documents according to preferred embodiments are depicted. The revised validation process 400 preferably comprises supplying an XML source file 410 (which may be equivalent to XML source file 310 of FIG. 3) and an XML schema 420 to parser 440. The XML schema 420 may have been revised since the XML source file 410 was created, and thus the source file might have become out of alignment with the schema to which it should adhere.

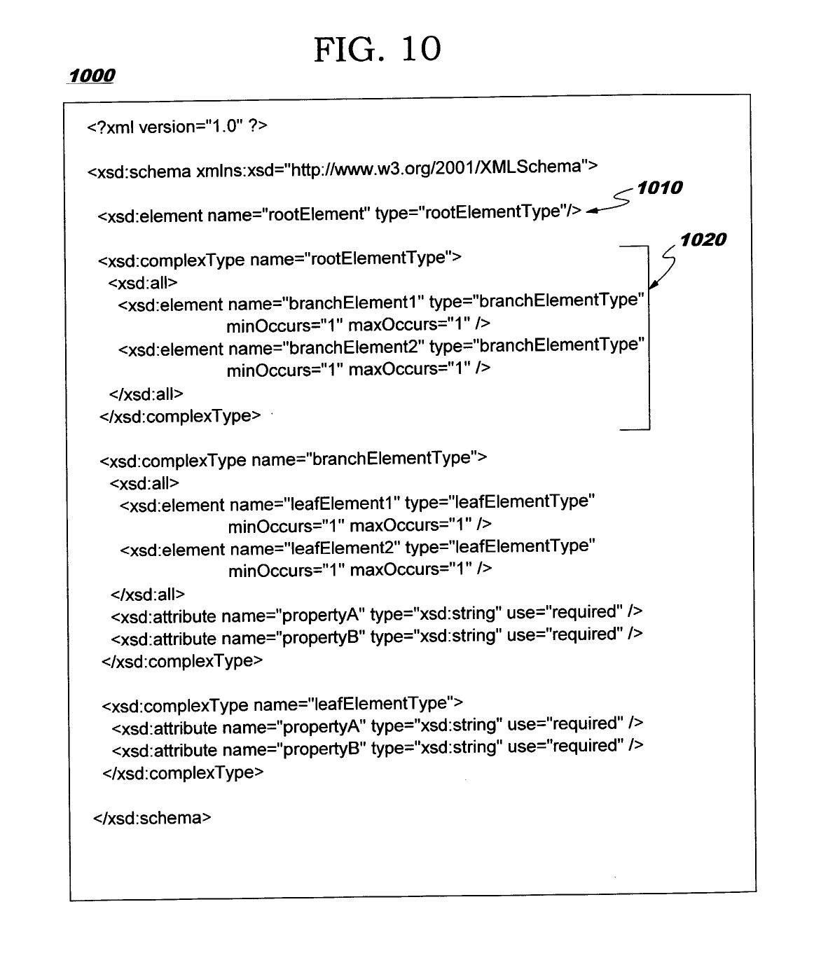

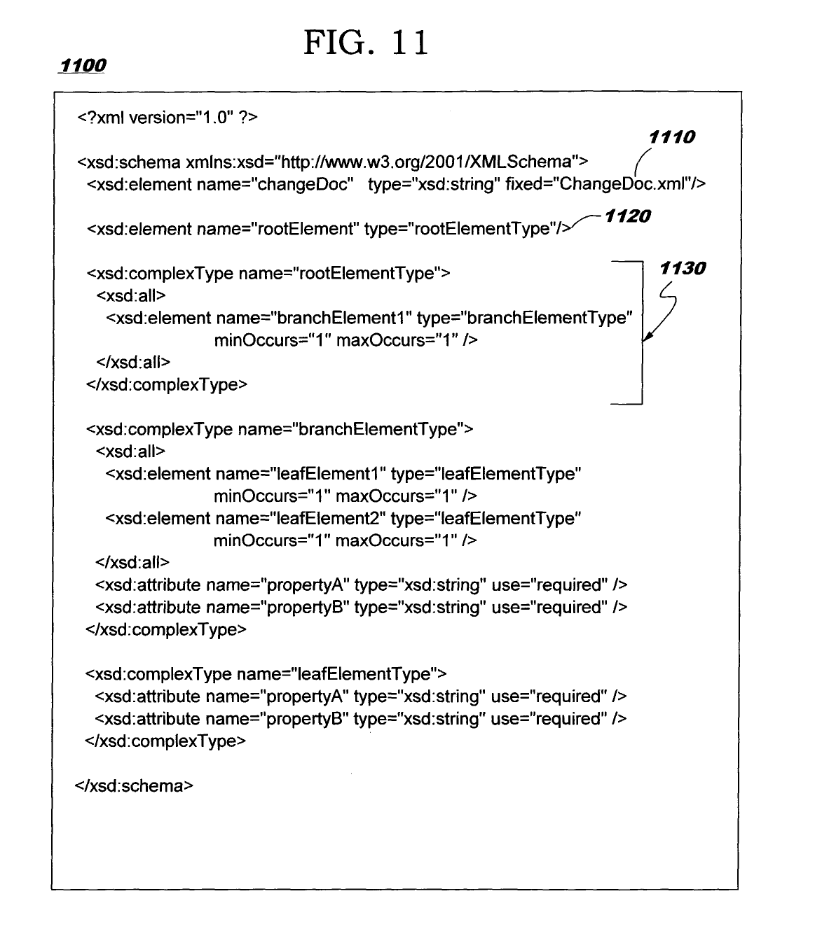

According to preferred embodiments, the schema 420 includes an identification of a “schema change document” 430 that has been created, according to preferred embodiments, to record changes that have been made to the schema. This schema change document provides a single point of access by parser 440 for implementing the programmatic revisions for a single XML file or for an entire set of XML files (referred to equivalently herein as “XML documents”) that may have become out of alignment with its schema. The manner in which the schema change document is identified, and how it is used to programmatically revise one or more XML files, will be described in detail below. (See, for example, the discussion of FIGS. 10-14.)

As described with reference to FIG. 3, outputs of the validation process 400 may include a parsed document 450 and/or a report of the validation errors 460 that were encountered. The report of validation errors preferably includes the out-of-alignment situations that are programmatically repaired by the present invention. Alternatively, the report might include only the non-repairable errors (in which case the errors are likely due to causes other than schema changes, such as programmer error when writing the code that generated the XML file 410 being validated).

In one aspect, the programmatic revisions are made only to an in-memory copy (e.g., the DOM tree) of a document being validated. In another aspect, the revisions can be used to rewrite the source document. Or, a separate copy of the source document, including the programmatic revisions, can be created in yet another aspect, thereby leaving the source document itself intact while persisting the revisions. Thus, FIG. 4 shows that another (optional) output of the validation process 400 may be a revised XML source file 470.

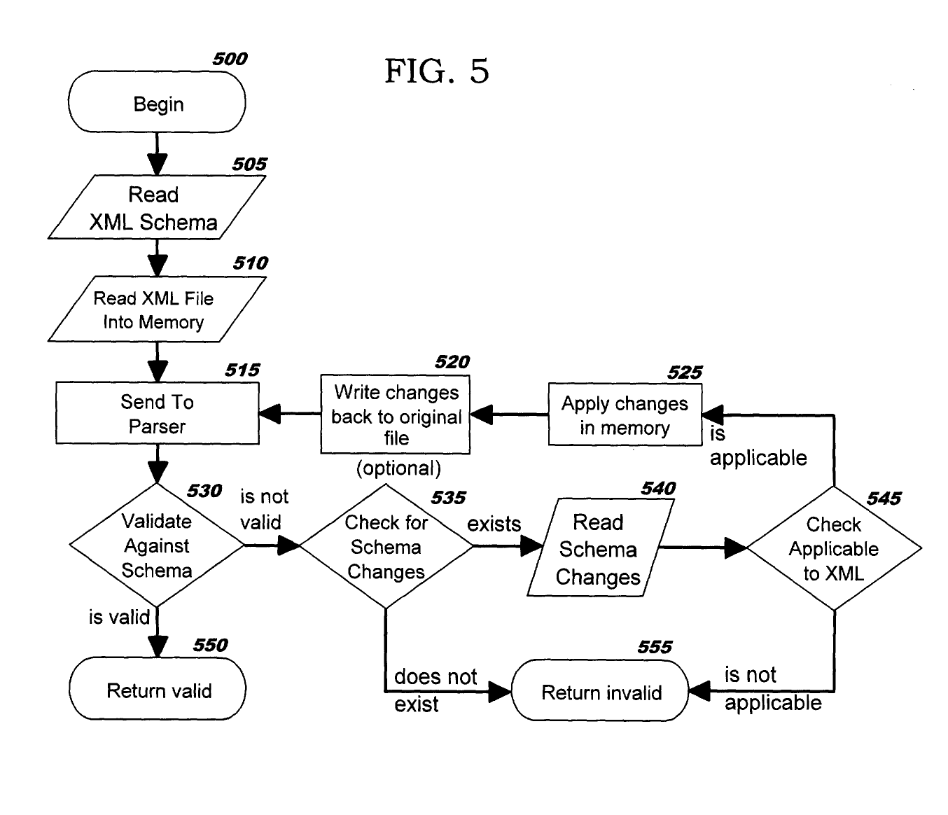

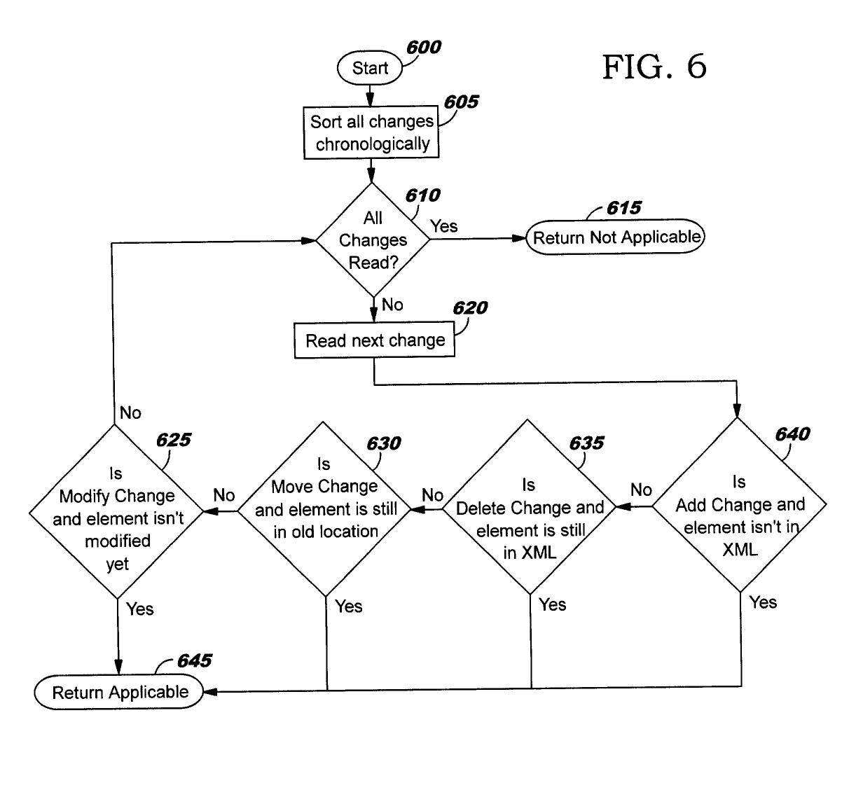

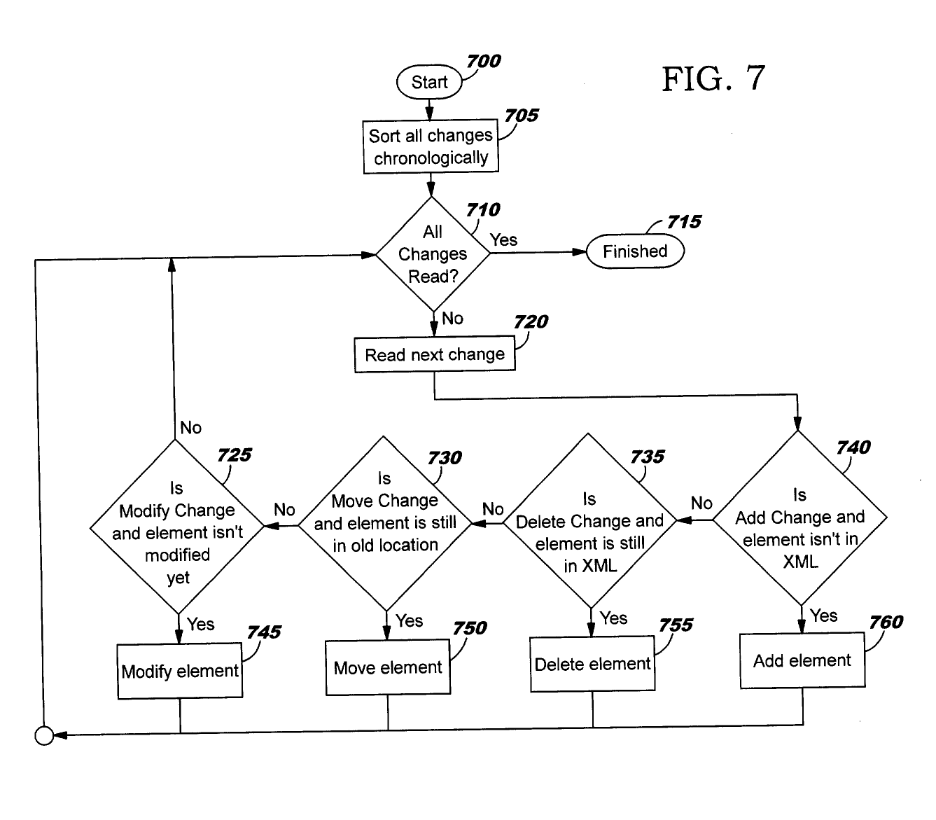

FIGS. 5-7 provide flowcharts illustrating logic that may be used when implementing preferred embodiments of the present invention. The flowchart in FIG. 5 illustrates operation of preferred embodiments of validation process 400, and FIGS. 6 and 7 provide further details, as will now be described.

The processing of FIG. 5 begins (Block 500) for a particular XML file to be validated, by reading the XML schema (Block 505) and the XML file (Block 510). (With reference to FIG. 4, Block 505 reads the schema 420 and Block 510 reads the XML source file 410.) At Block 515, the input files are sent to (i.e., read by) the parser (see element 440 of FIG. 4), which then validates the XML source file against the schema. The test in Block 530 indicates that, if the validation is successful, then the processing of FIG. 5 is complete and the validated file (see element 450 of FIG. 4) or, alternatively, simply a Boolean indicator of validity is returned (Block 550).

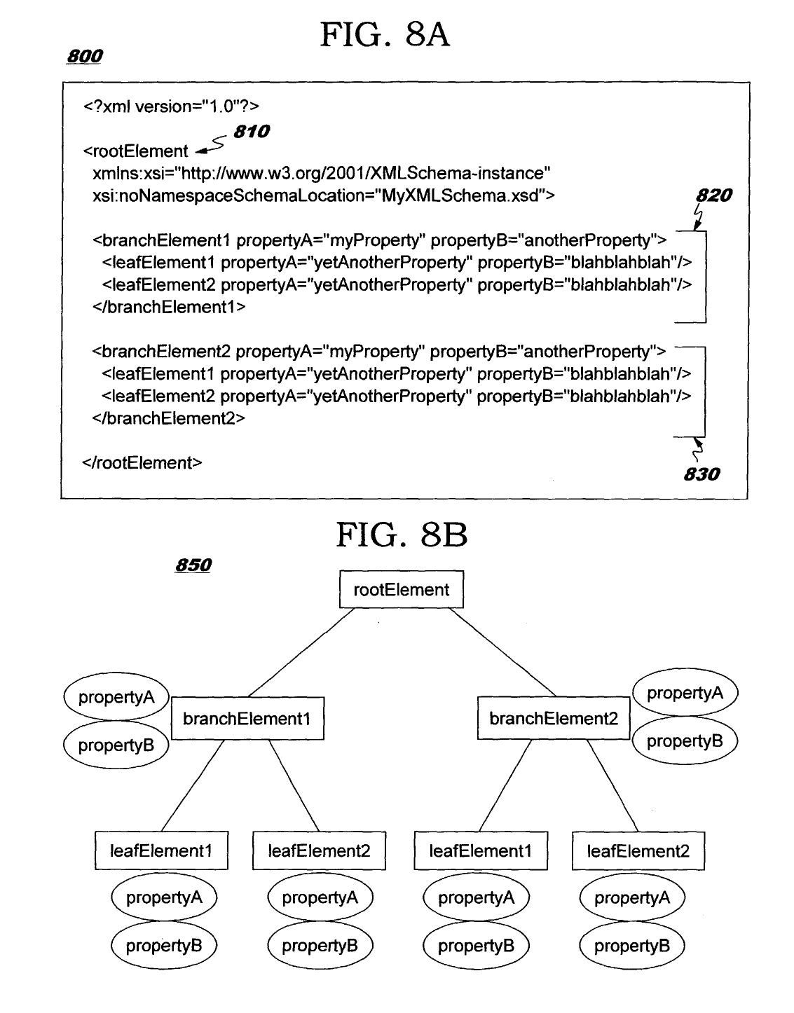

However, if the validation is not successful, then control transfers from Block 530 to Block 535, where a test is made to see if the schema used for this validation has changed. As stated earlier, in preferred embodiments, the schema read by the parser identifies a schema change document that records changes to the schema. Reference will now be made to the example documents in FIGS. 8-14 to illustrate how preferred embodiments programmatically detect schema changes and attempt programmatic repairs to an input file that has failed a validation (e.g., as represented by taking the “is not valid” branch from Block 530 to Block 535).

FIG. 8A provides a first sample XML document 800, comprising a root element named “rootElement” (see 810) that has two child elements. The first child element is named “branchelement1” (see 820) and the second child element is named “branchElement2” (see 830). Each of these elements has two child elements, named “leafElement1” and “leafElement2”. For this example document 800, all of the elements except for the root include two attributes, which (in each case) are named “propertyA” and “propertyB”. FIG. 8B provides a tree structure 850 that corresponds to document 800.

Suppose for purposes of discussion that document 800 was valid when it was created. An example of a schema that supports this document definition 800 is provided in FIG. 10, where schema 1000 includes the appropriate element and type definitions. See, for example, the type definition 1020 for “rootElementType”, which specifies that both “branchElement1” and “branchElement2” are required as child elements when using this type (and in particular, for the “rootElement” node 1010 that is defined to have this type).

Further suppose that the software developers then decide to remove “branchElement2” as a child of “rootElement”. A revised schema 1100 is provided in FIG. 11, and in this revised schema, the “rootElementType” for the element “rootElement” (see 1120) has a single child element, namely the “branchElement1” child (see 1130). Thus, when using schema 1100, the XML document 800 in FIG. 8A is invalid because the “branchElement2”element at 830 is not permitted.

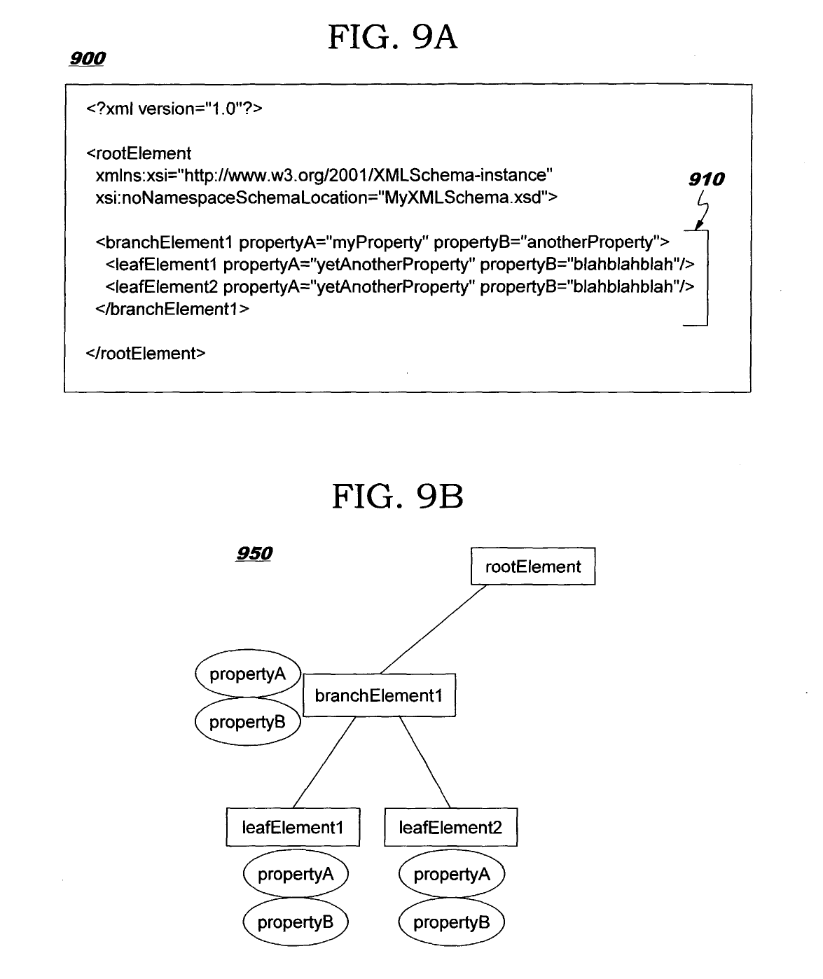

The XML document 900 in FIG. 9A, on the other hand, would be invalid if using schema 1000 of FIG. 10 for validation (because it lacks the required “branchElement2” element). This document 900 does, however, conform to the revised schema 1100 defined in FIG. 11, because in document 900, the “rootElement” element has only a “branchElement1” child (see 910). The tree 950 in FIG. 9B represents the document 900 shown in FIG. 9A.

Note that the “revised” schema 1100 shown in FIG. 11 includes a definition 1110 for a “changeDoc” element. This is an element used by preferred embodiments to embed a reference to the schema change document into a schema that has been revised. This schema change document is a document separate from the schema itself, and as stated earlier, is used to describe the changes made to the schema. According to preferred embodiments, this document contains information about one or more of the following types of changes:

1) Elements that have been added. The schema change document notes any elements that had been added. Optionally, an embodiment of the present invention may support specifying a default value to use during the programmatic migration process in cases where the XML file being validated did not contain this added element.

2) Elements that have been removed.

3) Elements that have been moved. The schema change document describes elements whose data was moved to another location in the schema. (Such changes may be represented in a similar manner to combining an “Element removed” and an “Element added” change, with the added benefit of the element's data being transferred to the new location.)

4) Elements that have been changed. The schema change document records elements whose definition changed. For example, if an optional value was changed to a required value, that would be reflected here.

As one example of a schema change that may be described in the schema change document, an element might be promoted within the schema, such that elements which had been its siblings are now its children. Or, similarly, an element might be demoted, such that it becomes a sibling of its former child elements.

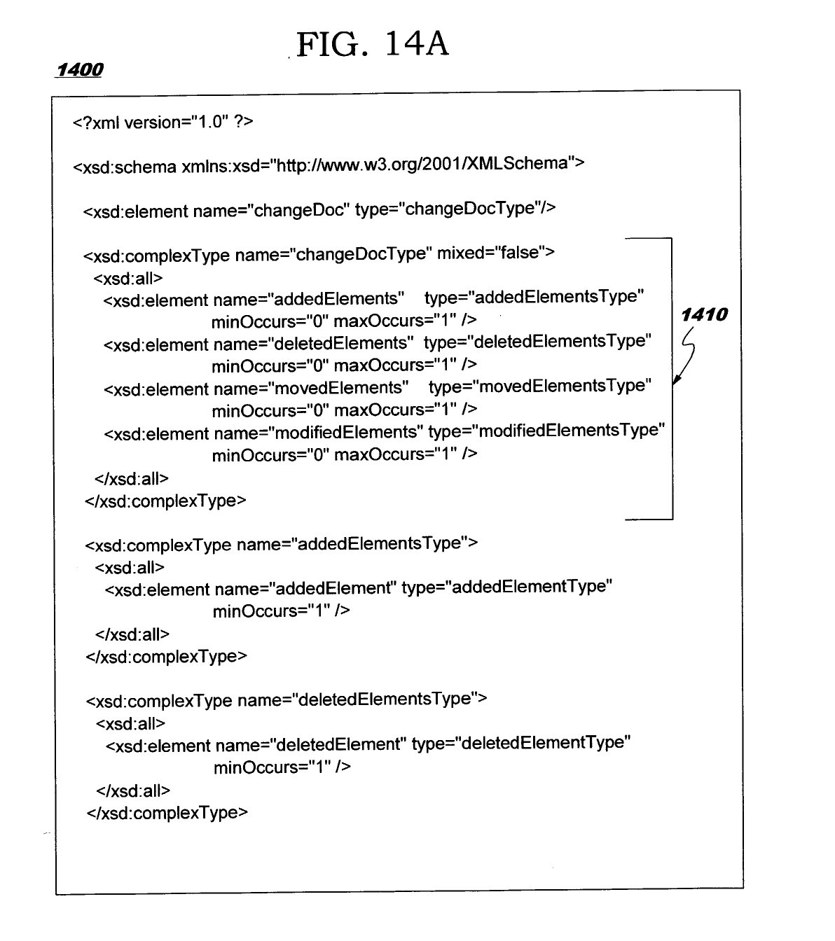

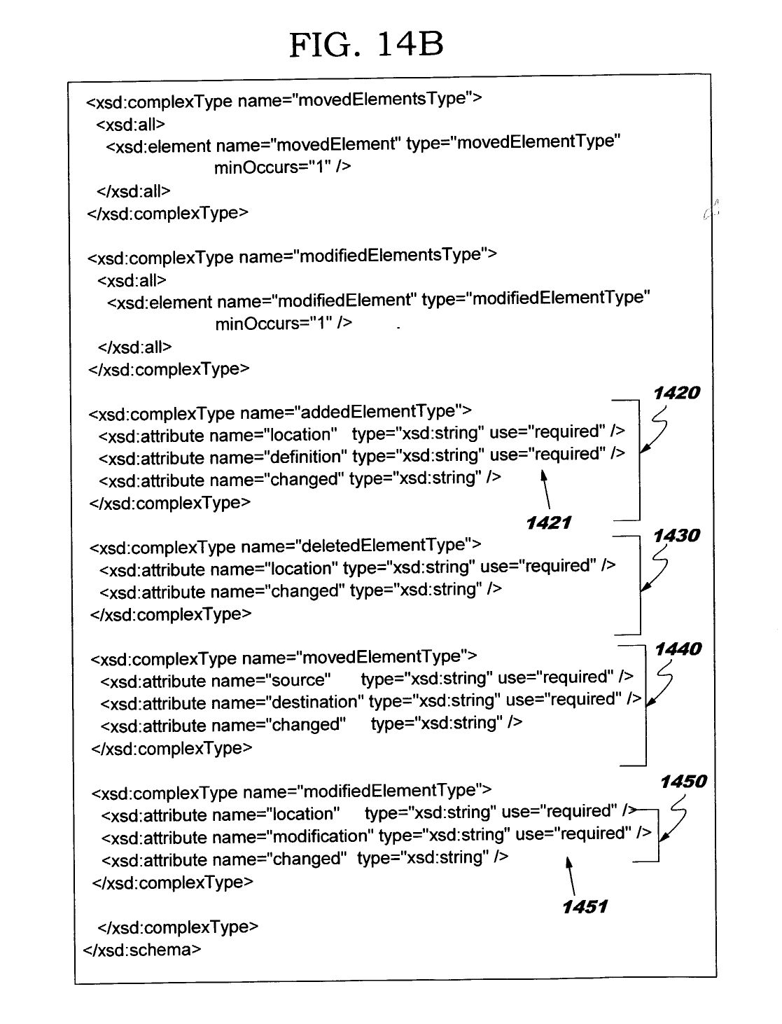

Additional and/or different types of changes may be specified in the schema change document, without deviating from the scope of the present invention. (As an example, identification of elements that have been renamed might be provided as another choice within the schema change document.) Furthermore, changes to properties/attributes may be specified within the tags for element changes (see the discussion of reference number 1450 of FIG. 14, for example), or separate tags may be provided for such changes.

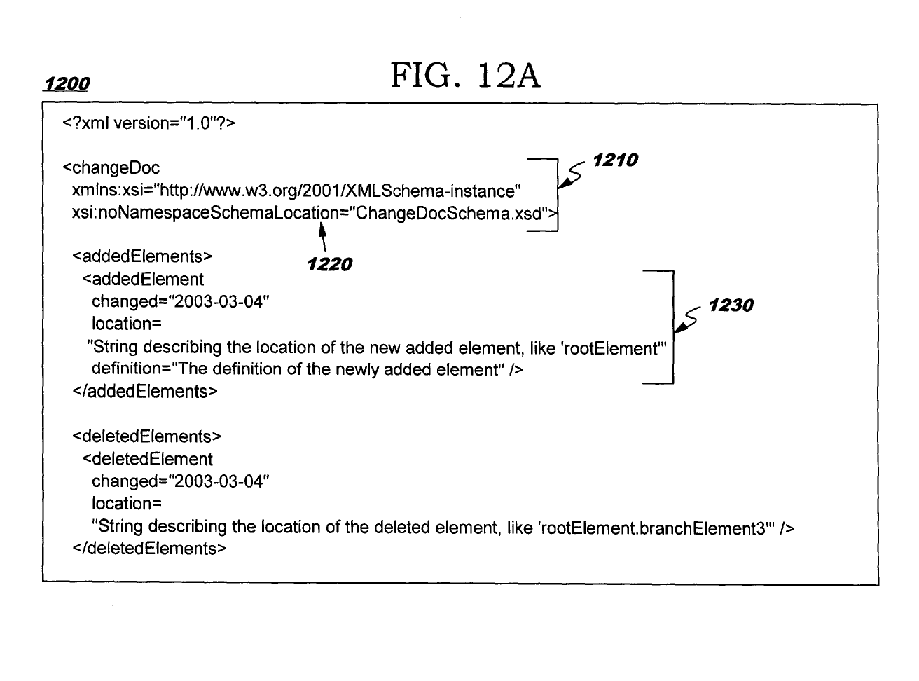

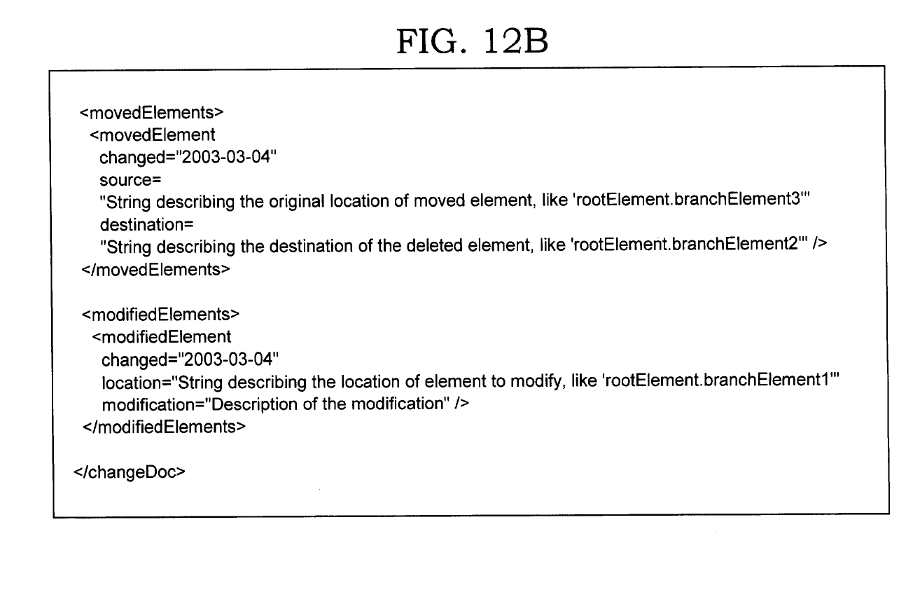

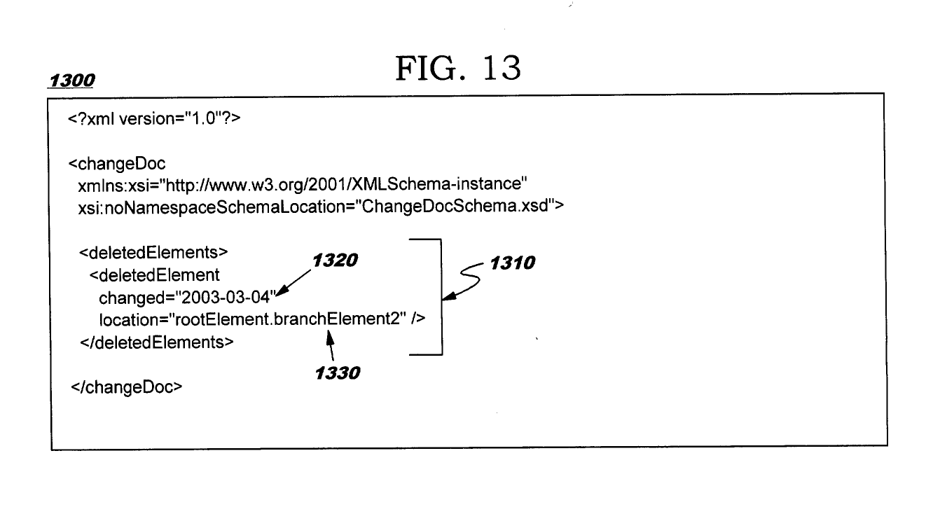

FIG. 12 (comprising FIGS. 12A and 12B) illustrates the general format of a sample schema change document, created according to preferred embodiments to record how a schema has been changed. As shown therein, document 1200 (which is an XML document) includes a “changeDoc” element 1210, which includes an attribute 1220 that specifies the location of the schema by which this schema change document itself is validated. Refer to FIG. 14 for an example of such a schema. Notably, the schema 1400 in FIG. 14 (comprising FIGS. 14A and 14B) allows for recording each of the four types of changes described above. See element 1410, which specifies that each of these is optional in a valid schema change document.

In FIG. 13, a sample schema change document 1300 is provided, where this sample document records how the schema in FIG. 10 was changed to create the schema in FIG. 11. In particular, this schema change document 1300 indicates (see 1310) that an element was deleted from the previous schema. This deletion has been described above with reference to the documents 800 and 900 of FIGS. 8A and 9A, where the “branchElement2” element was deleted as a child of the “rootElement” element. In the sample schema change document 1300, the attributes which are provided relative to this deletion are a “changed” attribute 1320 and a “location” attribute 1330. The “changed” attribute records the date of the change (e.g., as a form of audit trail). The “location” attribute specifies where, relative to the XML document structure defined in the previous schema, the deletion was made. In this example, the attributes indicate that the deletion was made on Mar. 4, 2003, and impacted a child of “rootElement” that was named “branchElement2”.

Many alternative syntax forms may be adopted for expressing the schema revisions, and thus the examples depicted in FIGS. 12-14 are for purposes of illustration but not of limitation. A syntax such as the existing XPointer (or XLink or XPath) notation may be advantageous for specifying values of the “location” attribute (and thereby identifying the location of the schema change). XPointer, XLink, and XPath are well known in the art, and published descriptions thereof are readily available; therefore, a detailed description thereof is not provided herein. The particular syntax used for describing schema changes may vary from one implementation to another without deviating from the scope of the present invention. The syntax that is adopted may use a combination of location/action pairs, whereby a pointer to a specific location in the schema is combined with a custom action tag to add/remove/move/change an element at that location.

Reference will now be made to the schema change definition 1400 of FIG. 14 (as illustrated by the sample document 1200 in FIG. 12) for a discussion of attributes that may be used when adding, removing, moving, and changing elements in a schema.

When an element is added to a schema, the “changed” and “location” attributes are preferably used in an analogous manner to that which has been described with reference to the “deletedElements” element 1310 in FIG. 13. See element 1420 of FIG. 14. In addition, a “definition” attribute (see 1421) is preferably used for specifying the syntax of the added element. Values of this attribute are preferably specified as strings, as shown at 1421, and these strings preferably contain markup language syntax for the added element.

Optionally, default values may be specified within the schema change document for the elements that are being added. (Alternatively, an implementation of the present invention may be adapted for supplying values in another manner. For example, the implementation might be coded to supply empty/null values, or to prompt a user for default values, and so forth.)

As one way in which default values may be specified within the schema change document, the <addedElement> element 1230 in FIG. 12 might be replaced by the following syntax (with a corresponding modification to the schema 1400 in FIG. 14):

```
<addedElement
  changed=“2003-03-04”
  location=
  “String describing the location of the new added element,
  like ‘rootElement’”
  definition=“The definition of the newly added element”>
```

<defaultData>

. . . Optional default data . . .

</defaultData>

</addedElement>

As another example, the following approach might be used, where a multi-line string is specified that contains new markup language syntax (where the syntax in this example supplies the specification for “branchElement2” and its child elements, as those elements are shown at reference number 830 of FIG. 8A):

<addedElement

changed=“2003-03-04”
location=
“String describing the location of the new added element,
like ‘rootElement’”
definition=

“<![CDATA[

<branchElement2 propertyA=“myProperty”
propertyB=“anotherProperty”>

<leafElement1 propertyA=“yetAnotherProperty”
propertyB=“blahblahblah”/>
<leafElement2 propertyA=“yetAnotherProperty”
propertyB=“blahblahblah”/>

</branchElement2>

]]>”

The migration can be carried out by inserting the new syntax, intact, into the file being migrated. This approach may also be used to provide default values for attributes/properties.

Element 1430 specifies allowable syntax for recording deleted elements, which have been described above.

For elements that have been moved when creating a revised schema, element 1440 indicates that preferred embodiments include attributes for the date of the change (i.e., the “changed” attribute), and for the “source” and “destination” of the move. Preferably, the values of the “source” and “destination” attributes are defined in a similar manner as the value of “location” attribute 1330. As noted above, moving an element within a schema may be considered analogous to first deleting the element from its original location, and then adding the element at its new location. Thus, alternative embodiments may omit support for moving elements without deviating from the scope of the present invention. (Note, however, that providing support for moving elements enables flexibly transferring the contents of the element.)

Element 1450 defines attributes that are preferably used for modified elements. Again, the “location” and “changed” attributes are preferably used to record the location and date of the modification. In addition, a “modification” element 1451 may be used to provide a description of a particular modification. Preferably, modifications are described in terms of added, deleted, moved, or modified properties/attributes. As noted above, these types of changes to properties/attributes may be specified within the tags for element changes, and in this case such changes may be specified within the <modifiedElement> definition of a schema change document (with a corresponding change to the syntax at 1450).

The discussion now returns to the validation process of FIG. 5, where (for purposes of illustration) the document 800 of FIG. 8A is being validated against the revised schema 1100 of FIG. 11. According to element 1130 of the schema, element 830 of the input document is invalid. Rather than simply returning an error (and halting further processing of the input file), as in the prior art, control reaches Block 535, where an attempt to repair the input document according to the present invention begins. Block 535 tests to see if any schema changes have been recorded that might be used for this purpose. In preferred embodiments, the input schema is checked to see if it contains a “changeDoc” element, and if so, then Block 535 has a positive result and control passes to Block 540. Referring to the sample input schema 1100 of FIG. 11, this “changeDoc” element is found at 1110. On the other hand, if there is no “changeDoc” element (for example, in the original schema 1000 of FIG. 10, which had not yet been revised), then the test in Block 535 has a negative result. This negative result indicates that the present invention is not able to repair the input document, and thus control transfers to Block 555 where an indicator of the invalidity (such as error report 460 of FIG. 4) is returned.

When control reaches Block 540, the repair (i.e., programmatic migration) process continues by reading the schema change document identified on the “changeDoc” element of the input schema. In the example input schema 1100, the document is identified as “ChangeDoc.xml”. Thus, this document is located and read. For purposes of illustration, assume that this identifies document 1300 of FIG. 13. Block 545 then tests to see if the changes recorded in the schema change document are applicable to the validation problem that has been identified in the current XML input file. The schema change document might record one or more changes, and thus this test represents an iterative process.

FIG. 6 provides an illustration of logic that may be used for implementing the test in Block 545. When this logic begins (Block 600), the changes recorded in the schema change document are first sorted into chronological order at Block 605 (which allows for changes that reference other changes to be properly interpreted). Block 610 checks to see if all the changes have been read. If so, then a change that applies to the current validation problem was not located, and the processing of FIG. 6 will therefore exit by returning a “not applicable” indication at Block 615.

Otherwise, when there are still more changes to evaluate, control reaches Block 620 which reads the next change from the sorted changes. Block 640 checks to see if (1) this is an added element change and (2) the current validation problem is that this added element is not present in the XML file being processed by FIG. 5. If this test has a positive result, then an “applicable” indication is returned at Block 645, and the processing of FIG. 6 exits.

When the test in Block 640 has a negative result, then Block 635 checks to see if (1) this is a deleted element change and (2) the current validation problem is that this element is still present in the XML file being processed by FIG. 5. If this test has a positive result, then an “applicable” indication is returned at Block 645, and the processing of FIG. 6 exits.

When the test in Block 635 has a negative result, then Block 630 checks to see if (1) this is a moved element change and (2) the current validation problem is that this element is not present in the correct place in the XML file being processed by FIG. 5. If this test has a positive result then an “applicable” indication is returned at Block 645, and the processing of FIG. 6 exits.

When the test in Block 630 has a negative result, then Block 625 checks to see if (1) this is a modify element change and (2) the current validation problem is that this element has improper syntax in the XML file being processed by FIG. 5. If this test has a positive result, then an “applicable” indication is returned at Block 645, and the processing of FIG. 6 exits.

Otherwise, when the test in Block 625 has a negative result (i.e., this change element is not applicable to the current validation problem), then control returns to Block 610 to determine whether there are any more changes to be evaluated.

Returning again to the discussion of FIG. 5, if the schema change document is not applicable to the current validation problem (that is, a “not applicable” indication was returned from Block 615 of FIG. 6), then this XML input file cannot be programmatically migrated according to the present invention, and control transfers to Block 555 where an invalidity indicator is returned.

On the other hand, if a recorded change is applicable to the current validation problem, then processing continues at Block 525 where the change is applied. Preferably, the change is made to the in-memory version of the XML input file.

FIG. 7 illustrates logic that may be used for implementing the processing of Block 525. Processing efficiencies may be realized by incorporating the logic of FIG. 6, which determines whether any schema changes are applicable to the current validation problem, with the actual application of the change. Thus, Blocks 700-740 are identical to Blocks 600-640, with the exception that Block 715 simply finishes or returns control to the invoking logic. The additional functionality represented in FIG. 7 comprises Block 745-760. Here, the applicable change that has been located in the schema change document is applied to modify, move, delete, or add an element, respectively, in the XML file being validated.

Following application of the change at Block 525, Block 520 optionally writes the revised file in place of the original file. Or, as discussed earlier, it may be desirable in some aspects to apply the changes only to the in-memory version (and to therefore omit Block 520), which enables efficiently rejecting changes if the file cannot be completely repaired. In other aspects, it may be desirable to make a copy of the input file, and write the changes to this copy at Block 520. In another approach, changes to the original file (or to the copy) may be delayed until determining that the file can be completely repaired. (For example, a “repaired” flag might be set following Block 525, and the function of Block 520 might then be moved to the “is valid” branch from Block 530 where it would be preceded by a test of the “repaired” flag and skipped if this flag is false.)

Following Block 520, or following Block 525 when Block 520 has been omitted, Block 515 sends the programmatically migrated XML file back through the parsing process. Block 530 will then validate this revised XML file against the input schema to determine whether there are any more elements that do not adhere to the schema. This validation process occurs as described above for the original input document, until either (1) performing enough repairs on the file that it will pass the validation or (2) determining that the file cannot be repaired in view of the recorded schema changes.

It should be noted that the approach described with reference to FIG. 5, where repairs are attempted only when a validation fails, is not intended to limit use of the present invention. Alternatively, repairs may be attempted in a proactive manner, such as checking for schema changes and applying any applicable changes before beginning the validation of a particular XML file or files.

While the examples discussed above refer to changes to elements defined in a schema, this should be construed as applying also to changes to properties defined in the schema (e.g., where these properties define allowable attributes for XML documents).

A number of optional enhancements may be provided in a particular implementation of the present invention. With regard to applying the changes documented in the schema change document to the XML file being validated, these enhancements include (but are not limited to) one or more of the following: (1) prompting the user to accept or reject changes; (2) prompting the user for additional data needed (e.g, instead of using default data); (3) alerting the user that changes are being made; (4) showing the user all changes that are necessary, and then exiting without actually making the changes; and (5) prompting the user to indicate whether changes should be written to the source XML file (and/or a copy thereof), or should only be applied to the in-memory copy.

As has been demonstrated, the present invention defines advantageous techniques for programmatically migrating an XML file such that it adheres to a current version of an XML schema. This migration may be done temporarily to each XML file at run-time, either as validation errors are discovered or as a precursor to attempting validation (as was discussed earlier). Or, the migration may be applied in a batch mode, whereby a number of XML files are preprocessed to determine whether they are valid. In the latter case, the repairs are preferably made permanent by overwriting the original (invalid) file. In the former case, the repairs may be permanent, or they may be temporary (e.g., in the form of modifications to an in-memory copy of the input file).

Advantages of the present invention include recording all schema changes in a single location (i.e., the schema change document, in preferred embodiments) while keeping the change history separate from, yet linked to, the schema itself. Furthermore, the disclosed techniques provide a migration/repair approach that operates in a “run-time progressive” mode (which may interactively involve a user, if desired). This is in contrast to prior art techniques, which are either run-time “regressive” (i.e., they try to validate the XML input file against an older version of the schema if the initial validation fails), or “batch progressive” (i.e., they require batch-mode revision of XML files, rather than providing dynamic, run-time migration). The temporary or transient, in-memory (e.g., DOM tree) modification approach disclosed herein is also advantageous in many situations, such as when a schema is volatile during software development. The disclosed techniques may be considered a “rule-based” repair approach, in that the changes specified in a schema change document may be considered rules that define the programmatic repairs that are allowable for a particular schema. This rule-based detection and migration approach is preferred over prior art techniques that are dependent on schema version numbers.

The disclosed techniques may also be used advantageously in methods of doing business, for example by providing dynamic data migration services for clients. This service may be provided under various revenue models, such as pay-per-use billing, monthly or other periodic billing, and so forth.

Commonly-assigned U.S. Pat. No.______ (Ser. No. 10/016,933), which is entitled “Generating Class Library to Represent Messages Described in a Structured Language Schema”, discloses techniques whereby class libraries are programmatically generated from a schema. Templates are used for generating code of the class libraries. According to techniques disclosed therein, optional migration logic can be programmatically generated to handle compatibility issues between multiple versions of an XML schema from which class libraries are generated. Multiple versions of an XML schema are read and compared, and a report of their differences is prepared. The differences are preferably used to generate code that handles both the original schema and the changed version(s) of the schema. The class library is then preferably programmatically re-generated such that it includes code for the multiple schema versions. This allows run-time functioning of code prepared according to any of the schema versions. The techniques disclosed therein are not directed toward enabling XML files that have become out of alignment with their schema to be programmatically migrated.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of programmatically migrating data, comprising steps of:
recording one or more changes that are made to a first structured language specification when creating a second structured language specification; and
using the recorded changes to programmatically migrate contents of a source file encoded to adhere to the first structured language specification such that it adheres to the second structured language specification.

2. The method according to claim 1, wherein the changes are recorded in a single location.

3. The method according to claim 1, wherein the changes are recorded in a change file.

4. The method according to claim 1, wherein the recorded changes are identified in, but are physically separate from, the second structured language specification.

5. The method according to claim 1, wherein the first structured language specification and the second structured language specification are schemas.

6. The method according to claim 1, wherein a subset of the recorded changes create an interim structured language specification from the first structured language specification and remaining ones of the recorded changes create the second structured language specification from the interim structured language specification, and wherein the source file that is programmatically migrated by the using step is encoded to adhere to the interim structured language specification.

7. The method according to claim 1, wherein the using step operates to programmatically migrate the contents of the source file responsive to detecting a validation error when attempting to validate the contents of the source file against the second structured language specification.

8. The method according to claim 1, wherein the using step operates to programmatically migrate the contents of the source file prior to attempting to validate the contents of the source file against the second structured language specification.

9. The method according to claim 1, wherein the programmatic migration further comprises revising the contents of the source file.

10. The method according to claim 1, wherein the programmatic migration further comprises revising an in-memory representation of the contents of the source file.

11. The method according to claim 1, wherein the programmatic migration further comprises revising a copy of the contents of the source file.

12. The method according to claim 1, further comprising the step of prompting a user before changing the contents of the source file during the programmatic migration.

13. The method according to claim 8, wherein the validation is performed by a parser.

14. The method according to claim 1, wherein the source file is encoded in a structured markup language and the first and second structured language specifications define allowable syntax for files encoded in the structured markup language.

15. The method according to claim 14, wherein the structured markup language is Extensible Markup Language (“XML”) or a derivative thereof.

16. A system for programmatically migrating data, comprising:
means for recording one or more changes that are made to a first structured language specification when creating a second structured language specification; and
means for using the recorded changes to programmatically migrate contents of a source file encoded to adhere to the first structured language specification such that it adheres to the second structured language specification.

17. The system according to claim 16, wherein the recorded changes are identified in, but are physically separate from, the second structured language specification.

18. The system according to claim 16, wherein the first structured language specification and the second structured language specification are schemas.

19. The system according to claim 16, wherein the means for using operates to programmatically migrate the contents of the source file responsive to detecting a validation error when attempting to validate the contents of the source file against the second structured language specification.

20. The system according to claim 16, wherein the means for using operates to programmatically migrate the contents of the source file prior to attempting to validate the contents of the source file against the second structured language specification.

21. The system according to claim 16, wherein the programmatic migration further comprises revising one or more of: the contents of the source file; an in-memory representation of the contents of the source file; and a copy of the contents of the source file.

22. The system according to claim 16, wherein the source file is encoded in a structured markup language and the first and second structured language specifications define allowable syntax for files encoded in the structured markup language.

23. A computer program product for programmatically migrating data, the computer program product embodied on one or more computer-usable media and comprising:
computer-readable program code means for recording one or more changes that are made to a first structured language specification when creating a second structured language specification; and
computer-readable program code means for using the recorded changes to programmatically migrate contents of a source file encoded to adhere to the first structured language specification such that it adheres to the second structured language specification.

24. The computer program product according to claim 23, wherein the recorded changes are identified in, but are physically separate from, the second structured language specification.

25. The computer program product according to claim 23, wherein the first structured language specification and the second structured language specification are schemas.

26. The computer program product according to claim 23, wherein the computer-readable program code means for using operates to programmatically migrate the contents of the source file responsive to detecting a validation error when attempting to validate the contents of the source file against the second structured language specification.

27. The computer program product according to claim 23, wherein the computer-readable program code means for using operates to programmatically migrate the contents of the source file prior to attempting to validate the contents of the source file against the second structured language specification.

28. The computer program product according to claim 23, wherein the programmatic migration further comprises revising one or more of: the contents of the source file; an in-memory representation of the contents of the source file; and a copy of the contents of the source file.

29. The computer program product according to claim 23, wherein the source file is encoded in a structured markup language and the first and second structured language specifications define allowable syntax for files encoded in the structured markup language.

30. A method of programmatically migrating data such that it aligns with a changing definition of allow syntax, comprising steps of:
recording one or more changes that are made to a first structured language specification when creating a second structured language specification, wherein syntax of one or more source files is intended to adhere to the first structured language specification;
upon determining that the syntax of the one or more source files should now adhere to the second structured language specification, using the recorded changes to programmatically migrate contents of at least one of the source files, such that the syntax does adhere to the second structured language specification; and
charging a fee for carrying out either or both of the recording and programmatically migrating steps.
